(19) United States
(12) Patent Application Publication
(10) Pub. No.: US 2019/0100923 A1
(43) Pub. Date: Apr. 4, 2019

(54) SYSTEM FOR SECURING SHADE MATERIAL TO A ROLLER SHADE

(71) Applicant: Crestron Electronics, Inc., Rockleigh, NJ (US)

(72) Inventor: Agnieszka Wynar, Wallington, NJ (US)

(73) Assignee: Crestron Electronics, Inc., Rockleigh, NJ (US)

(21) Appl. No.: 15/722,223

(22) Filed: Oct. 2, 2017

(51) Int. Cl. E04F 10/06; E06B 9/44

(52) U.S. Cl. CPC E04F 10/0633; E06B 2009/445; E06B 9/44

(57) ABSTRACT

A channel for receiving a retaining member to secure shade material to a roller shade is provided. The channel comprises a first and second retaining lip sections that define an opening into the interior cavity of the channel, a first bottom wall section opposite the first retaining lip and aligned along a first plane, and a second bottom wall section opposite the second retaining lip and aligned along a second plane offset from the first plane. The second retaining lip comprises an outer lip wall that tapers towards the interior cavity and is aligned along the same first plane as the first bottom wall section. The top end of the retaining member is inserted through the opening and into the interior cavity along the first plane under the first retaining lip and over the outer lip wall and the first bottom wall section. The retaining member is then rotated into place from being aligned with the first plane to being aligned with the second plane such that a bottom end of the retaining member is positioned between the second retaining lip and the second bottom wall section. The retaining member secures a portion of the shade material within the interior cavity of the channel.

### BACKGROUND OF THE INVENTION

### Technical Field

Aspects of the embodiments relate to shades, and more particularly to systems, methods, and modes for securing shade material to a roller shade.

### Background Art

Roller shades are effective in screening windows, doors, or the like, to achieve privacy and thermal effects. A roller shade typically includes a rectangular shade material, such as fabric, attached at its top end to a cylindrical rotating tube, called a roller tube, and at an opposite bottom end to a hem bar. The shade material is wrapped around the roller tube. The roller tube is rotated, either manually or via an electric motor, in a first direction to roll down the shade material to cover a window and in a second direction to roll up the shade material to uncover the window.

Typically, the shade material is attached to the roller tube using double sided tape. However, it is difficult for an untrained user to replace the shade material if the shade material needs to be replaced for some reason, for example, due to damage or when the user wishes to change shade material color or design. Aside from peeling off the old shade material and replacing the tape, the installer has to ensure that the shade material is attached perfectly square to the tube. If the shade material is not square to the tube, the shade material will not roll up straight and will telescope left or right, causing the shade material to rub against the window frame. This leads to a crooked, wrinkled, and/or damaged shade.

To simplify changing the shade material, a spline or a strip may be used to secure the shade material within a channel in the roller tube. However, often such a solution requires the shade material and the strip to be slid into position from the end of the roller tube. This may cause the shade material to pucker and may damage the shade when trying to slide-in shade material of substantial width.

Another solution enables the strip to be snapped or pressed into the channel from the side of the roller tube. However, such channels are generally constructed with a large depth to enable the insertion and retention of the strip. Often the walls forming the channel, the retention strip, or a snap fastener, protrude beyond the outer diameter of the roller tube, creating a bump in the shade material when the shade material is rolled up on the roller tube, which causes unsightly impression or indent in the shade material when it is rolled down. In other designs, to keep the outer profile of the roller tube smooth, the strip retaining channel is buried deeper within the roller tube. This results in thicker, wider, and heavier roller tube, limits the space for the motor drive unit inside the roller tube, and in some designs offsets the motor drive unit from the center axis of the roller tube due to the variable thickness of the roller tube, which may cause improper or uneven operation. To decrease the depth of the channel, another solution offers a deformable strip, creating movable parts that are prone to breakage.

Accordingly, a need has arisen for a system for simplifying the process of securing shade material to a roller shade without causing damage to the shade material and while maintaining a small and substantially constant thickness and smooth profile of the roller tube.

### SUMMARY OF THE INVENTION

It is an object of the embodiments to substantially solve at least the problems and/or disadvantages discussed above, and to provide at least one or more of the advantages described below.

It is therefore a general aspect of the embodiments to provide systems, methods, and modes for securing shade material to a roller shade that will obviate or minimize problems of the type previously described.

More particularly, the aspects of the embodiments provide a system for simplifying the process of securing the shade material to a roller shade without causing damage to the shade material and while maintaining a small and substantially constant thickness and smooth profile of the roller tube.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Further features and advantages of the aspects of the embodiments, as well as the structure and operation of the various embodiments, are described in detail below with reference to the accompanying drawings. It is noted that the aspects of the embodiments are not limited to the specific embodiments described herein. Such embodiments are presented herein for illustrative purposes only. Additional embodiments will be apparent to persons skilled in the relevant art(s) based on the teachings contained herein.

### DISCLOSURE OF INVENTION

According to an aspect of the embodiments a roller shade is provided comprising a shade material, a retaining member, and a roller tube. The roller tube comprises a substantially cylindrical outer surface and a channel recessed in the outer surface. The channel in the roller tube comprises an opening in the outer surface of the roller tube that extends between a first retaining lip and a second retaining lip and provides access into an interior cavity of the channel. The channel further comprises a bottom wall comprising a first bottom wall section opposite the first retaining lip and aligned along a first plane, and a second bottom wall section opposite the second retaining lip and aligned along a second plane offset from the first plane. The second retaining lip comprises an outer lip wall that extends from the outer surface of the roller tube to a tip of the second retaining lip and tapers towards the interior cavity, wherein the outer lip wall is aligned along the same first plane as the first bottom wall section. The retaining member secures the top end of the shade material within the interior cavity of the channel in the roller tube.

According to an embodiment, the first retaining lip may comprise a first inner lip wall and the second retaining lip comprises a second inner lip wall. The first inner lip wall may be longer than the second inner lip wall. According to a further embodiment, the channel may further comprise a first side wall laterally extending from a first end connected to the first retaining lip wall and a second end connected to the first bottom wall section, and a second side wall laterally extending and connected between the second retaining lip wall and the second bottom wall section. The first side wall may be connected to the first inner lip wall at an obtuse angle, and the first side wall may be connected to the first bottom wall section at an acute angle. According to an embodiment, the retaining member is inserted into the interior cavity along the first plane under the first retaining lip wall and over the outer lip wall and the first bottom wall, and rotated into place from being aligned with the first plane to being aligned with the second plane. The first side wall may be tapered away from the first inner lip wall such that as the retaining member is rotated the retaining member is translated towards the second side wall by the tapering of the first side wall. According to an embodiment, a distance between the second end of the first side wall and the tip of the second retaining lip is larger than a width of the retaining member, and a distance between the first end of the first side wall and the tip of the second retaining lip is smaller than the width of the retaining member. According to another embodiment, when the retaining member is secured within the interior cavity, a top end of the retaining member locks the shade material against the first inner lip wall of the first retaining lip, and a bottom end of the retaining member locks against the second bottom wall section of the channel.

According to an embodiment, to secure the retaining member in the cavity, a top end of the retaining member is wrapped by the top end of the shade material, the top end of the retaining member is inserted through the opening into the interior cavity of the channel along the first plane under the first retaining lip and over the outer lip wall and the first bottom wall section, the retaining member is rotated from being aligned with the first plane to being aligned with the second plane, and a bottom end of the retaining member is slid along the second plane until being positioned between the second retaining lip and the second bottom wall section.

According to an embodiment, the roller shade further comprises a ridge formed between the first bottom wall section and the second bottom wall section that protrudes into the interior cavity. According to another embodiment, the outer lip wall and the first bottom wall section of the cannel that rest on the first plane guide the retaining member into the channel. The opening may be smaller than a width of the retaining member such that the retaining member is retained within the channel by the first retaining lip and the second retaining lip.

According to an embodiment, the top end of the shade material is attached to a first side of the retaining member. The shade material may be attached to the retaining member via heat welding, stitching, adhesive, a thermoplastic layer, a film, or the like, or any combinations thereof. The shade material may be folded over a second side of the retaining member.

According to an embodiment, the channel does not protrude beyond the perimeter of the substantially cylindrical outer surface of the roller tube. The roller tube may comprise a substantially cylindrical wall comprising the substantially cylindrical outer surface and an inner cavity with a substantially cylindrical inner surface, wherein the channel is formed in the cylindrical wall of the roller tube such that it is substantially contained within the cylindrical wall and does not protrude beyond the perimeter of the substantially cylindrical outer surface or beyond the perimeter of the substantially cylindrical inner surface into the inner cavity of the roller tube. The cylindrical wall of the roller tube may comprise a substantially constant thickness such that the inner surface is substantially concentric with the outer surface.

According to another aspect of the embodiments, a channel for receiving a retaining member to secure shade material to a roller shade is provided. The channel comprises a first and second retaining lip sections that define an opening into the interior cavity of the channel, a first bottom wall section opposite the first retaining lip and aligned along a first plane, and a second bottom wall section opposite the second retaining lip and aligned along a second plane offset from the first plane. The second retaining lip may comprise an outer lip wall that tapers towards the interior cavity and is aligned along the same first plane as the first bottom wall section. The top end of the retaining member may be inserted through the opening and into the interior cavity along the first plane under the first retaining lip and over the outer lip wall and the first bottom wall section. The retaining member may then be rotated into place from being aligned with the first plane to being aligned with the second plane such that a bottom end of the retaining member is positioned between the second retaining lip and the second bottom wall section. As such, the retaining member secures a portion of the shade material within the interior cavity of the channel.

According to a further aspect of the embodiments, a method is provided for securing shade material to a roller shade. The roller shade comprises a channel having an opening between a first retaining lip and a second retaining lip, an interior cavity, a first bottom wall section opposite the first retaining lip and aligned along a first plane, and a second bottom wall section opposite the second retaining lip and aligned along a second plane offset from the first plane. The second retaining lip may comprise an outer lip wall that tapers towards the interior cavity and is aligned along the same first plane as the first bottom wall section. According to an embodiment, the method comprises the steps of: wrapping a top end of a retaining member with the shade material, inserting the top end of the retaining member through the opening into the interior cavity along the first plane under the first retaining lip and over the outer lip wall and the first bottom wall section, and rotating the retaining member from being aligned with the first plane to being aligned with the second plane. According to an embodiment, the bottom end of the retaining member is slid along the second plane until being positioned between the second retaining lip and the second bottom wall section. According to an embodiment, the step of wrapping a top end of a retaining member with the shade material may comprise attaching the top end of the shade material to a first side of the retaining member, and folding the shade material over a second side of the retaining member.

According yet to a further aspect of the embodiments a roller shade is provided comprising a shade material, a retaining member, and a hem bar comprising an outer surface and a channel recessed in the outer surface. The channel comprises an opening in the outer surface of the hem bar that extends between a first retaining lip and a second retaining lip and provides access into an interior cavity of the channel. The channel also comprises a bottom wall comprising a first bottom wall section opposite the first retaining lip and aligned along a first plane, and a second bottom wall section opposite the second retaining lip and aligned along a second plane offset from the first plane. The channel further comprises an outer lip wall that extends from the outer surface of the hem bar to a tip of the second retaining lip and tapers towards the interior cavity. The outer lip wall may be aligned along the same first plane as the first bottom wall section. The retaining member secures the bottom end of the shade material within the interior cavity of the channel in the hem bar.

### BRIEF DESCRIPTION OF THE DRAWINGS

The above and other objects and features of the embodiments will become apparent and more readily appreciated from the following description of the embodiments with reference to the following figures. Different aspects of the embodiments are illustrated in reference figures of the drawings. It is intended that the embodiments and figures disclosed herein are to be considered to be illustrative rather than limiting. The components in the drawings are not necessarily drawn to scale, emphasis instead being placed upon clearly illustrating the principles of the aspects of the embodiments. In the drawings, like reference numerals designate corresponding parts throughout the several views.

### BRIEF DESCRIPTION OF THE SEVERAL VIEWS OF THE DRAWINGS

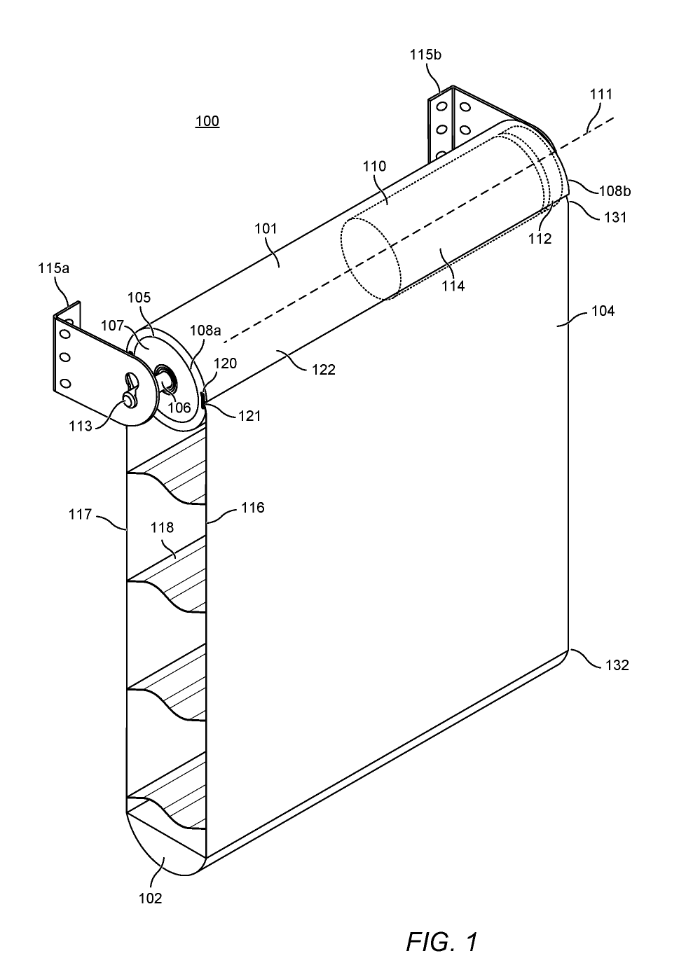

FIG. 1 illustrates a front perspective view of a roller shade according to one aspect of the embodiments.

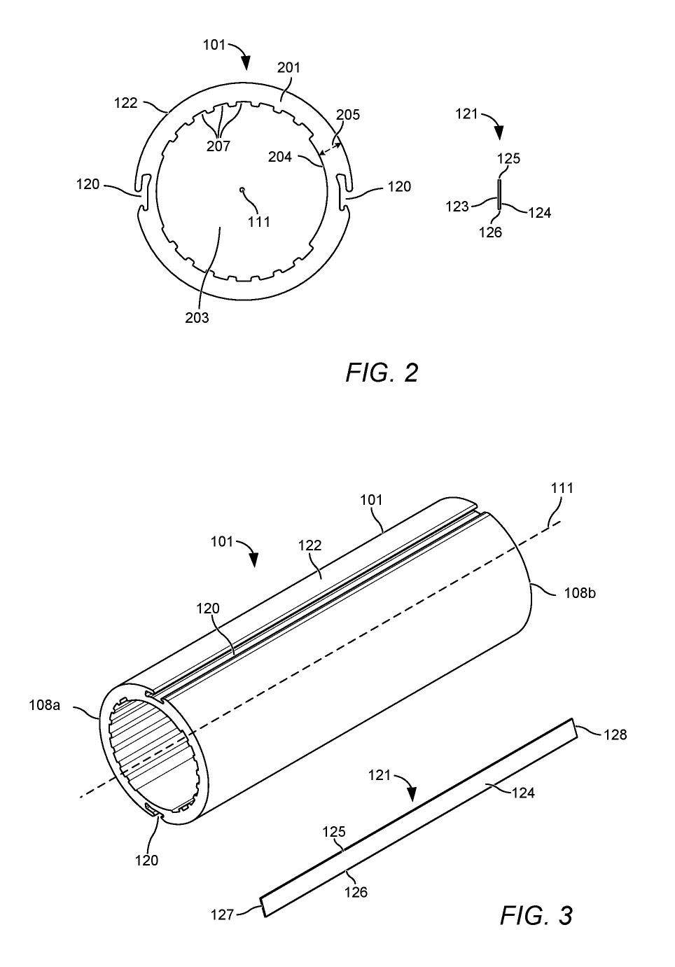

FIG. 2 illustrates a cross sectional view of a roller tube and a retaining member of the roller shade according to one aspect of the embodiments.

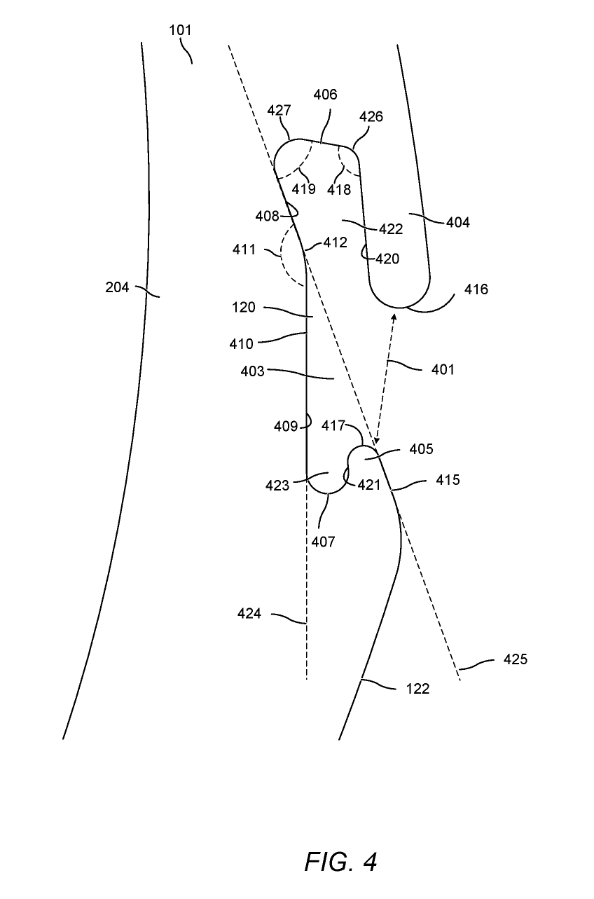

FIG. 3 illustrates a perspective view of the roller tube and the retaining member of the roller shade according to one aspect of the embodiments.

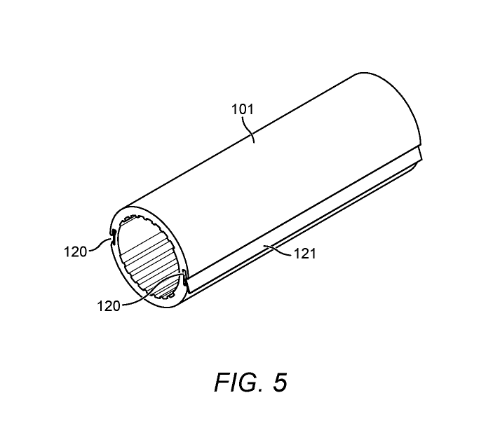

FIG. 4 illustrates a cross sectional view of a channel in the roller tube according to one aspect of the embodiments.

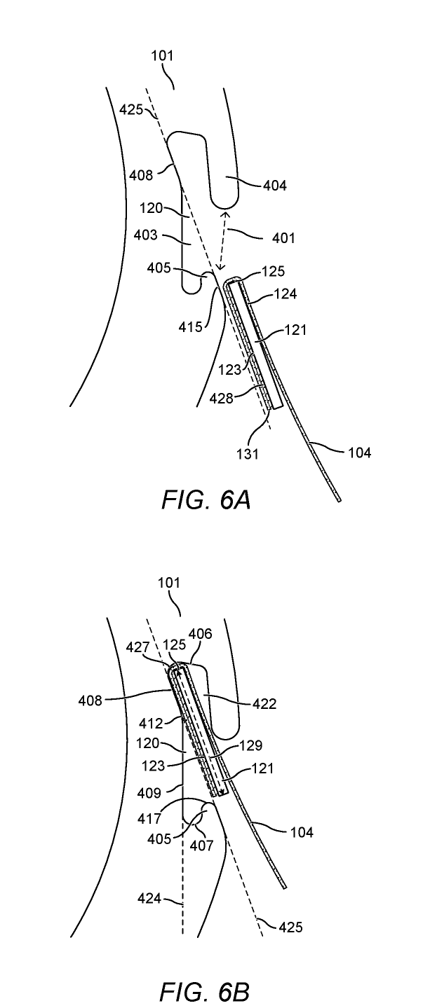

FIG. 5 illustrates a perspective view of the retaining member partially inserted into the channel of the roller tube according to one aspect of the embodiments.

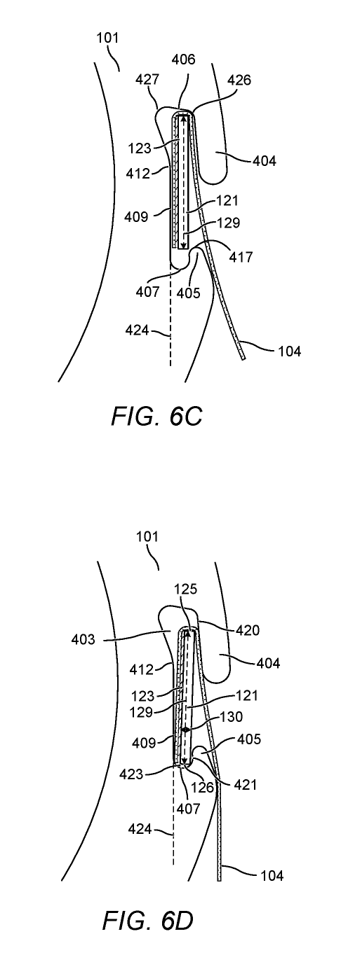

FIGS. 6A-6D show a cross sectional view of the channel illustrating the steps of securing the shade material to the channel via the retaining member according to one aspect of the embodiments.

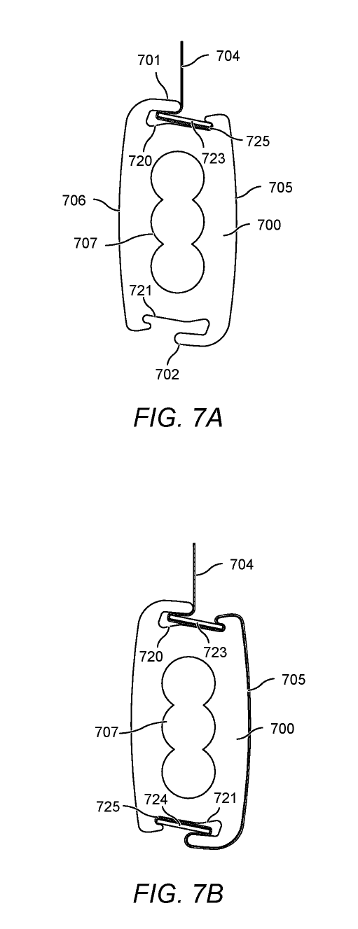

FIG. 7A illustrates a cross sectional view of a hem bar containing a channel used to secure the shade material to the hem bar according to one aspect of the embodiments.

FIG. 7B illustrates a cross sectional view of the hem bar containing two channels used to secure the shade material to the hem bar in a half-wrap configuration according to one aspect of the embodiments.

### DETAILED DESCRIPTION OF THE INVENTION

The embodiments are described more fully hereinafter with reference to the accompanying drawings, in which embodiments of the inventive concept are shown. In the drawings, the size and relative sizes of layers and regions may be exaggerated for clarity. Like numbers refer to like elements throughout. The embodiments may, however, be embodied in many different forms and should not be construed as limited to the embodiments set forth herein. Rather, these embodiments are provided so that this disclosure will be thorough and complete, and will fully convey the scope of the inventive concept to those skilled in the art. The scope of the embodiments is therefore defined by the appended claims. The detailed description that follows is written from the point of view of a control systems company, so it is to be understood that generally the concepts discussed herein are applicable to various subsystems and not limited to only a particular controlled device or class of devices.

Reference throughout the specification to “one embodiment” or “an embodiment” means that a particular feature, structure, or characteristic described in connection with an embodiment is included in at least one embodiment of the embodiments. Thus, the appearance of the phrases “in one embodiment” on “in an embodiment” in various places throughout the specification is not necessarily referring to the same embodiment. Further, the particular feature, structures, or characteristics may be combined in any suitable manner in one or more embodiments.

### LIST OF REFERENCE NUMBERS FOR THE ELEMENTS IN THE DRAWINGS IN NUMERICAL ORDER

The following is a list of the major elements in the drawings in numerical order.
100 Roller Shade
101 Roller Tube
102 Hem Bar
104 Shade Material
105 Idler Assembly
106 Idler Pin
107 Idler Body
108a First End
108b Second End
110 Roller Shade Drive Unit
111 Longitudinal Axis
112 Motor Control Module
113 Pin Tip
114 Motor
115a First Mounting Bracket
115b Second Mounting Bracket
116 First Sheer Material
117 Second Sheer Material
118 Horizontal Vanes
120 Channel
121 Retaining Member
122 Outer Surface
123 First Side
124 Second Side
125 Top End
126 Bottom End
127 First End
128 Second End
129 Retaining Member Width
130 Retaining Member Depth
131 Top End
132 Bottom End
201 Cylindrical Wall
203 Inner Cavity
204 Inner Surface
205 Thickness
207 Inner Channels
401 Opening
403 Interior Cavity
404 First Retaining Lip
405 Second Retaining Lip
406 First Side Wall
407 Second Side Wall
408 First Bottom Wall Section
409 Second Bottom Wall Section
410 Bottom Wall
411 First Angle
412 Ridge
415 Outer Lip Wall
416 First Tip
417 Second Tip
418 Second Angle
419 Third Angle
420 First Inner Lip Wall
421 Second Inner Lip Wall
422 First Retaining Cavity
423 Second Retaining Cavity
424 Second Plane
425 First Plane
426 First End
427 Second End
428 Adhesive
700 Hem Bar
701 Top End
702 Bottom End
704 Shade Material
705 Front Wall
706 Rear Wall
707 Cavity
720 First Channel
721 Second Channel
723 First Retaining Member
724 Second Retaining Member
725 Bottom End

### MODE(S) FOR CARRYING OUT THE INVENTION

For 40 years Crestron Electronics, Inc. has been the world's leading manufacturer of advanced control and automation systems, innovating technology to simplify and enhance modern lifestyles and businesses. Crestron designs, manufactures, and offers for sale integrated solutions to control audio, video, computer, and environmental systems. In addition, the devices and systems offered by Crestron streamlines technology, improving the quality of life in commercial buildings, universities, hotels, hospitals, and homes, among other locations. Accordingly, the systems, methods, and modes of the aspects of the embodiments described herein can be manufactured by Crestron Electronics Inc., located in Rockleigh, N.J.

The different aspects of the embodiments described herein pertain to the context of roller shades, but is not limited thereto, except as may be set forth expressly in the appended claims. While the roller shade is described herein for covering a window, the roller shade may be used to cover doors, wall openings, or the like. The embodiments described herein may further be adapted in other types of window or door coverings, such as inverted rollers, Roman shades, Austrian shades, pleated shades, blinds, shutters, skylight shades, garage doors, or the like.

Referring to FIG. 1, there is shown a front perspective view of a roller shade 100 according to one embodiment. Roller shade 100 generally comprise a roller tube 101, shade material 104, and a hem bar 102. During installation, the roller shade 100 may be mounted on or in a window between a first and second mounting brackets 115a and 115b. Shade material 104 is connected at its top end to the roller tube 101 and at its bottom end to the hem bar 102. Shade material 104 wraps around the roller tube 101 and is unraveled from the roller tube 101 to cover a window, a door, a wall opening, or the like. In various embodiments, the shade material 104 comprises fabric, plastic, vinyl, or other materials known to those skilled in the art. According to one embodiment, the shade material 104 may comprise a single layer of shade material that rolls up on the roller tube 101. In another embodiment, as shown in FIG. 1, the shade material 104 may comprise a first sheer material 116 connected to a second parallel sheer material 117 via a plurality of horizontal vanes 118. Such shade material 104 rolls off the roller tube 101 with all the vanes 118 folded up. Once the entire length of the shade material 104 is rolled down (as shown in FIG. 1), the vanes 118 may be tilted out by further rotation of the roller tube 101.

Roller tube 101 is generally cylindrical in shape and laterally extends from a first end 108a to a second end 108b along longitudinal axis 111. The roller tube 101 may comprise an outer surface 122. The roller tube 101 may comprise one or more recessed channels 120 in the outer surface 122 of the roller tube 101 that extends from the first end 108a to the second end 108b of the roller tube 101 along longitudinal axis 111. For example, a single channel 120 may be used to retain a single layered shade material, while two channels 120 may be used to retain the double layered shade material 104 as shown in FIG. 1. Each channel 120 is used to retain the shade material 104 via a retaining member 121, as will be further described in greater detail below.

The roller tube 101 may be connected to an idler assembly 105 at its first end 108a. The idler assembly 105 may comprise an idler pin 106 and an idler body 107. The idler body 107 may be rotatably connected about the idler pin 106 via ball bearings therein (not shown). It is inserted into the roller tube 101 and is operably connected to the roller tube 101 such that rotation of the idler body 107 also rotates the roller tube 101. The idler pin 106 may include a pin tip 113 disposed on the terminal end of the idler pin 106 to attach the roller shade 100 to the first mounting bracket 115a. In one embodiment, the idler body 107 may comprise similar configuration to the idler body having a counterbalancing assembly disclosed in U.S. Pat. No. 9,631,425, issued on Apr. 25, 2017, and titled “Roller Shade with a Pretensioned Spring a Method for Pretensioning the Spring,” the entire contents of which are hereby incorporated by reference.

According to one embodiment, the second send 108b of the roller tube 101 may comprise a similar idler assembly 105 having an idler pin connected to the second mounting bracket 115b. In another embodiment, idler pin 106 may extend from the first end 108a to the second end 108b of the roller tube 101 and be connected to the first and second mounting brackets 115a and 115b. The roller shade 100 may be rolled down (closed) and rolled up (opened) manually or semi-manually by pulling or tugging on the hem bar 101 or by pulling on a chain (not shown).

According to another embodiment, the second end 108b of the roller tube 102 receives the roller shade drive unit 110. The roller shade drive unit 104 may comprise a motor control module 112 and a motor 114. The roller shade drive unit 104 may further comprise a drive wheel (not shown) that fits within the roller tube 101 and is connected to the output shaft of the motor 114 to rotate the roller tube 101. In operation, the roller shade 100 is rolled down and rolled up via the roller shade drive unit 110. Particularly, the motor 114 drives the drive wheel, which in turn engages and rotates the roller tube 101; and the roller tube 101 engages and rotates the idler body 107 with respect to the motor 114, while the motor 114 and motor control module 112 remain stationary. As a result, the shade material 104 may be lowered from an opened or rolled up position, when substantially the entire shade material 104 is wrapped about the roller tube 101, to a closed or rolled down position, when the shade material 104 is substantially unraveled. The motor control module 112 may comprise fully integrated electronics to control the motor 114, directing the operation of the motor, including its direction, speed, and position.

Referring to FIGS. 2-3, FIG. 2 shows a cross sectional view of the roller tube 101 and the retaining member 121, and FIG. 3 shows a perspective view of the roller tube 101 and the retaining member 121. According to an embodiment, the roller tube 101 is hollow and comprises a cylindrical wall 201 that defines an inner cavity 203. The cylindrical wall 201 comprises a substantially cylindrical outer surface 122 and a substantially cylindrical inner surface 204.

The inner surface 204 of the roller tube 101 may comprise a plurality of inner channels 207 extending circumferentially therein along longitudinal axis 111. Inner channels 207 are used to mate with complementary projections formed on the idler assembly 105 and/or the roller shade drive unit 110, to enable the driving mechanism of the roller shade 100, such as the motor 114, to drive the roller tube 101.

At least one channel 120 extends in the outer surface 122 of the roller tube 101 from the first end 108a to the second end 108b of the roller tube 101 along longitudinal axis 111. For example, to receive the double layered shade material 104 shown in FIG. 1, two channels 120 may be formed in tube 101 spaced about 180 degrees from each other. According to an embodiment, the roller tube 101 with the inner channels 207 and the outer channels 120 may be formed as a single piece of material via an extrusion process. In various embodiments, the roller tube 101 comprises aluminum, stainless steel, plastic, fiberglass, or other materials known to those skilled in the art.

Each channel 120 is configured to receive a retaining member 121. According to an embodiment, the retaining member 121 may comprise a strip or a spline with a substantially rectangular cross section. Although other shaped retaining member 121 may be utilized. The retaining member 121 may extend from a first end 127 to a second end 128 and may comprise a top end 125, a bottom end 126, a first side 123, and a second side 124. According to one embodiment, the retaining member 121 may comprise a flexible plastic tape material. Although in various embodiment, the retaining member 121 may comprise rubber, aluminum, stainless steel, resilient plastic, thermoplastic, fiberglass, or other materials known to those skilled in the art.

The channel 120 of the present embodiments comprises a novel shape that provides a plurality of benefits. It allows the retaining member 121 to be inserted into the channel 120 from the side of the roller tube 101, directly through the outer surface 122, as shown in FIG. 5, instead of sliding the retaining member 121 from the first end 108a to the second end 108b, which can cause unintentional bunching and rippling along the width of the shade material 104. As such, the installation process of the present embodiment is simple and can be used by an untrained user to replace the shade material.

In addition, the channel 120 is formed in the cylindrical wall 201 of the roller tube 101 such that it is substantially contained within the cylindrical wall 201 and does not protrude beyond the perimeter of the substantially cylindrical outer surface 122 or beyond the perimeter of the substantially cylindrical inner surface 204 into the inner cavity 203 of the roller tube 101. Accordingly, the cylindrical wall 201 comprises a substantially smooth outer surface 122 and substantially constant thickness 205 such that the inner surface 204 is substantially concentric with the outer surface 122. This allows the driving mechanism of the roller shade 100, whether mechanical (e.g., a spring assembly) or electrical (i.e., a motor), to be centrally retained within the inner cavity 203 of the roller tube 101 without any encumbrances, and thereby ensures substantially equal weight distribution. In addition, when the shade material 104 is attached to the roller tube 101 and wrapped around the roller tube 101, no bump will be created in the shade material 104, thereby preventing unsightly impressions or indents in the shade material 104. Furthermore, the shade material 104 to tube attachment system described herein does not compromise the thickness 205 of the roller tube 101, allowing the thickness 205 of the roller tube 101, and thereby its weight, to be maintained small.

Referring to FIG. 4, there is shows a cross sectional view of the channel 120 in the roller tube 101 in greater detail. Channel 120 comprises an opening 401 in the outer surface 122 of the roller tube 101 that extends between a tip 416 of a first retaining lip 404 and a tip 417 of a second retaining lip 405. Opening 401 permits access into an interior cavity 403 of the channel 120. The first retaining lip 404 comprises a first inner lip wall 420 and the second retaining lip 405 comprises a second inner lip wall 421. According to an embodiment, the first retaining lip 404, and thereby first inner lip wall 420, is longer than the second retaining lip 405, and thereby the second inner lip wall 421. The channel 120 further comprises an interior cavity 403 that extends from a first side wall 406 to an oppositely disposed second side wall 407. The first side wall 406 is connected to the second side wall 407 via a transversely extending bottom wall 410 disposed opposite the opening 401. The first inner lip wall 420, first side wall 406, bottom wall 410, second side wall 407, and second inner lip wall 421 enclose the interior cavity 403 of the channel 120. Interior cavity 403 may comprise a first retaining cavity 422 and a second retaining cavity 423.

The bottom wall 410 comprises a first bottom wall section 408 connected to a second bottom wall section 409 at a first angle 411, forming a ridge 412 therebetween, which protrudes into the interior cavity 403. First angle 411 may, for example, comprise an obtuse angle of about 160 degrees. As such, the first bottom wall section 408 may be aligned along a first plane 425 and the second bottom wall section 409 may be aligned along a second plane 424, offset from the first plane 425 at, for example, about 20 degrees.

The first side wall 406 may laterally extend between a first end 426 connected to the first inner lip wall 420 and a second end 427 connected to the first bottom wall section 408. The first side wall 406 may be connected to the first inner lip wall 420 at a second angle 418, which may comprise and obtuse angle of about 105 degrees. The first side wall 406 may be connected to the first bottom wall section 408 a third angle 419, which may comprise an acute angle of about 60 degrees. As such, the first side wall 406 may be tapered away from the first inner lip wall 420. First inner lip wall 420, first side wall 406, and first bottom wall section 408 may define a first retaining cavity 422.

The second side wall 407 may laterally extend between the second inner lip wall 421 and second bottom wall section 409. The second inner lip wall 421 may be substantially parallel to the second bottom wall section 409, or it may be slightly offset, for example, at about five degrees. The second inner lip wall 421, second side wall 407, and second bottom wall section 409 may define a second retaining cavity 423.

The second retaining lip 405 may comprise an outer lip wall 415 that extends from the outer surface 122 of the roller tube 101 to the tip 417 of the second retaining lip 405. The outer lip wall 415 is tapered away from the outer surface 122 towards the interior cavity 403. The outer lip wall 415 may, for example, be offset from the second inner lip wall 421 by about fifteen degrees. The lip wall 415 is further aligned along the same first plane 425 as the first bottom wall section 408.

FIGS. 6A through 6D show a cross sectional view of the channel 120, shade material 104, and retaining member 121 illustrating the steps of securing the shade material 104 to the roller tube 101 via the retaining member 121 and channel 120. Referring to FIG. 6A, initially, the top end 131 of the shade material 104 may be attached to a side, such as the first side 123, of the retaining member 121. According to an embodiment, the top end 131 of the shade material 104 may be attached to the retaining member 121 via an adhesive 428. According to other embodiments, the retaining member 121 may be secured to the shade material 104 via heat welding, stitching, adhesive, a thermoplastic layer, film, or strip, or other binding materials known to those skilled in the art. In yet another embodiment, the retaining member 121 may comprise a thermoplastic material, such as PVC (or polyvinyl chloride), that can be directly welded to the shade material 104 by applying heat to the retaining member 121, for example, using a heat welding machine. However, the retaining member 121 may secure the shade material 104 in the retaining channel 120 without being attached to the shade material 104. Attaching the shade material 104 to the retaining member 121 simplifies the instillation process making the shade material 104 easier to handle and be secured to the roller tube 101.

After attaching the retaining member 121 to the shade material 104, the shade material 104 may be folded over the second side 124 of the retaining member 121, as shown in FIG. 6A. The retaining member 121 may then be inserted into the channel 120 in the outer surface 122 of the roller tube 101, as shown in FIG. 5, which does not illustrates the shade material 104 for illustrative purposes only. Particularly, referring to FIG. 6A, the retaining member 121 with the wrapped shade material 104 may be aligned with the first plane 425 and positioned with the first side 123 containing the adhesive 428 against the outer lip wall 415 of the second retaining lip 405. The top end 125 of the retaining member 121 is then inserted into the channel 120 through opening 401 and slid into the interior cavity 403 under the first retaining lip 404 along first plane 425. The outer lip wall 415 and the first bottom wall section 408 of cannel 120 that rest on first plane 425 guide the retaining member into the channel 120.

As shown in FIG. 6B, the retaining member 121 is inserted into the channel 120 along the first plane 425 until the top end 125 of the retaining member 121 is contained in the first retaining cavity 422 and abuts (indirectly through shade material 104) the second end 427 of the first side wall 406 of the channel 120. In that position, the first side 123 of the retaining member 121 may also abut (indirectly through shade material 104) the first bottom wall section 408.

The retaining member 121 is then rotated about the ridge 412 from being aligned with the first plane 425 to being aligned with the second plane 424 where the first side 123 of the retaining member 121 abuts (indirectly through shade material 104) the second bottom wall section 409 as shown in FIG. 6C. Referring back to FIG. 6B, rotation is possible because the distance between the second end 427 of the first side wall 406 and the tip 417 of the second retaining lip 405 is slightly larger than the width 129 of the retaining member 121 plus the thickness of the wrapped shade material 104. As the retaining member 121 is rotated about ridge 412 to a position shown in FIG. 6C, the retaining member 121 is translated downwardly towards second side wall 407 by the tapering of the first side wall 406. The distance between the first end 426 of the first side wall 406 and the tip 417 of the second retaining lip 405 may be smaller than the width 129 of the retaining member 121. As such, once rotated, the retaining member 121 is retained by the first retaining lip 404 and the second retaining lip 405 and cannot exit the channel 120. According to an embodiment, a longitudinally extending tool with a handle (not shown) may be used to rotate or push the retaining member 121 into the channel 120.

As shown in FIG. 6D, the bottom end 126 of the retaining member 121 is then slid between the second inner lip wall 421 and the second bottom wall section 409 along the second plane 424 until the bottom end 126 is contained within the second retaining cavity 423 and abuts the second side wall 407 of the channel 120. The distance between the second bottom wall section 409 and the second inner lip wall 421 may be slightly larger than the depth 130 of the retaining member 121 plus the thickness of the wrapped shade material 104. The top end 125 of the retaining member 121 abuts (indirectly through shade material 104) the first inner lip wall 420 of the first retaining lip 404.

Accordingly, the retaining member 121 is retained within the interior cavity 403 by the first retaining lip 404 and the second retaining lip 405. Because the opening 401 (FIG. 4) is smaller than the width 129 of the retaining member 121, the retaining member 121 cannot exit the channel 120. Furthermore, in use, when the shade material 104 is fully unraveled to close a window, the weight of the shade material 104, including the hem bar 102, exert a downward force that locks the top end 125 of the retaining member 121, and thereby the shade material 104, against the first inner lip wall 420 of the first retaining lip 404, and locks the bottom end 126 of the retaining member 121 against the second side wall 407 of the channel 120.

The shade material 104 may be removed from the roller tube 101 by sliding the retaining member 121 along the length of the channel 120 out of either the first end 108a or the second end 108b of the roller tube 101.

According to another embodiment, the shade material attachment embodiment discussed herein can also be included in a hem bar of a roller shade. Referring to FIG. 7A, there is shown a cross sectional view of a hem bar 700. The hem bar 700 may comprise a top end 701, a bottom end 702, a front wall 705, and a rear wall 706. The top end 701 may comprise a first longitudinally extending channel 720 comprising the novel shape substantially similar to channel 120 discussed above. According to a further embodiment, the bottom end 702 of the hem bar 700 may comprise a second longitudinally extending channel 721 comprising the novel shape substantially similar to channel 120 discussed above.

The bottom end 725 of the shade material 704 may be secured in the first channel 720 via a retaining member 723 in the same manner discussed above such that the hem bar 700 hangs down from the shade material 704 and is fully exposed.

In another embodiment, as shown in FIG. 7B, the bottom end 725 of the shade material 704 may be secured in the second channel 721 via a second retaining member 724. The shade material 704 may be further wrapped over the front wall 705 of the hem bar 700 and be secured in the first channel 720 via a first retaining member 720. This achieves a half wrap of the hem bar 700.

The design of the channels 720 and 721 allows for a simple attachment of the hem bar 700 to a shade material 702, which can be done directly in the field to replace a damaged hem bar or fabric. The slim design of the channels 720 and 721 leave plenty of room within the hem bar 700 to retain components. For example, the hem bar 700 may comprise a hallow cavity 707 that may receive one or more weights, for example in the form of steel rods, to add extra weight to the hem bar 700. In other embodiments, batteries (not shown) may be included within the hem bar 700 to power the roller shade. According to an embodiment, as shown in FIGS. 7A-7B, the shape of the hem bar 700, including the orientation of the first and second channels 720 and 721, may be symmetrically inverted such that particular orientation is not required for assembly. As such, the hem bar 700 may be installed with end 701 pointing upwards, or with end 702 pointing upwards. According to another embodiment, the second channel 721 may be used to receive a strip attached to light blocking material, such as bristles, felt, or liner material, to assist with light blocking.

### INDUSTRIAL APPLICABILITY

The disclosed embodiments provide a system, software, and a method for securing shade material to a roller shade. It should be understood that this description is not intended to limit the embodiments. On the contrary, the embodiments are intended to cover alternatives, modifications, and equivalents, which are included in the spirit and scope of the embodiments as defined by the appended claims. Further, in the detailed description of the embodiments, numerous specific details are set forth to provide a comprehensive understanding of the claimed embodiments. However, one skilled in the art would understand that various embodiments may be practiced without such specific details.

Although the features and elements of aspects of the embodiments are described being in particular combinations, each feature or element can be used alone, without the other features and elements of the embodiments, or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

The above-described embodiments are intended to be illustrative in all respects, rather than restrictive, of the embodiments. Thus the embodiments are capable of many variations in detailed implementation that can be derived from the description contained herein by a person skilled in the art. No element, act, or instruction used in the description of the present application should be construed as critical or essential to the embodiments unless explicitly described as such. Also, as used herein, the article “a” is intended to include one or more items.

Additionally, the various methods described above are not meant to limit the aspects of the embodiments, or to suggest that the aspects of the embodiments should be implemented following the described methods. The purpose of the described methods is to facilitate the understanding of one or more aspects of the embodiments and to provide the reader with one or many possible implementations of the processed discussed herein. The steps performed during the described methods are not intended to completely describe the entire process but only to illustrate some of the aspects discussed above. It should be understood by one of ordinary skill in the art that the steps may be performed in a different order and that some steps may be eliminated or substituted.

All United States patents and applications, foreign patents, and publications discussed above are hereby incorporated herein by reference in their entireties.

### Alternate Embodiments

Alternate embodiments may be devised without departing from the spirit or the scope of the different aspects of the embodiments.

What is claimed is:

1. A roller shade comprising:
a shade material comprising a top end;
a retaining member; and
a roller tube comprising a substantially cylindrical outer surface and a channel recessed in the outer surface, wherein the channel comprises:
an opening in the outer surface of the roller tube that extends between a first retaining lip and a second retaining lip and provides access into an interior cavity of the channel;
a bottom wall comprising a first bottom wall section opposite the first retaining lip and aligned along a first plane, and a second bottom wall section opposite the second retaining lip and aligned along a second plane offset from the first plane;
wherein the second retaining lip comprises an outer lip wall that extends from the outer surface of the roller tube to a tip of the second retaining lip and tapers towards the interior cavity, wherein the outer lip wall is aligned along the same first plane as the first bottom wall section;
wherein the retaining member secures the top end of the shade material within the interior cavity of the channel in the roller tube.

2. The roller shade of claim 1 further comprising a ridge formed between the first bottom wall section and the second bottom wall section that protrudes into the interior cavity.

3. The roller shade of claim 1 wherein the first retaining lip comprises a first inner lip wall and the second retaining lip comprises a second inner lip wall.

4. The roller shade of claim 3, wherein the first inner lip wall is longer than the second inner lip wall.

5. The roller shade of claim 3, wherein the channel further comprises:
a first side wall laterally extending from a first end connected to the first retaining lip wall and a second end connected to the first bottom wall section; and
a second side wall laterally extending and connected between the second retaining lip wall and the second bottom wall section.

6. The roller shade of claim 5, wherein the first side wall is connected to the first inner lip wall at an obtuse angle, and wherein the first side wall is connected to the first bottom wall section at an acute angle.

7. The roller shade of claim 5, wherein the retaining member is inserted into the interior cavity along the first plane under the first retaining lip wall and over the outer lip wall and the first bottom wall, and rotated into place from being aligned with the first plane to being aligned with the second plane.

8. The roller shade of claim 7, wherein the first side wall is tapered away from the first inner lip wall, wherein as the retaining member is rotated the retaining member is translated towards the second side wall by the tapering of the first side wall.

9. The roller shade of claim 5, wherein a distance between the second end of the first side wall and the tip of the second retaining lip is larger than a width of the retaining member, and wherein a distance between the first end of the first side wall and the tip of the second retaining lip is smaller than the width of the retaining member.

10. The roller shade of claim 5, wherein when the retaining member is secured within the interior cavity, a top end of the retaining member locks the shade material against the first inner lip wall of the first retaining lip, and wherein a bottom end of the retaining member locks against the second bottom wall section of the channel.

11. The roller shade of claim 1,
wherein a top end of the retaining member is wrapped by the top end of the shade material;
wherein the top end of the retaining member is inserted through the opening into the interior cavity of the channel along the first plane under the first retaining lip and over the outer lip wall and the first bottom wall section;
wherein the retaining member is rotated from being aligned with the first plane to being aligned with the second plane; and
wherein a bottom end of the retaining member is slid along the second plane until being positioned between the second retaining lip and the second bottom wall section.

12. The roller shade of claim 1, wherein the outer lip wall and the first bottom wall section of the cannel that rest on the first plane guide the retaining member into the channel.

13. The roller shade of claim 1, wherein the opening is smaller than a width of the retaining member such that the retaining member is retained within the channel by the first retaining lip and the second retaining lip.

14. The roller shade of claim 1, wherein the top end of the shade material is attached to a first side of the retaining member.

15. The roller shade of claim 14, wherein the shade material is attached to the retaining member via at least one selected from heat welding, stitching, adhesive, a thermoplastic layer, a film, and any combinations thereof.

16. The roller shade of claim 14, wherein the shade material is folded over a second side of the retaining member.

17. The roller shade of claim 1, wherein the channel does not protrude beyond the perimeter of the substantially cylindrical outer surface of the roller tube.

18. The roller shade of claim 1, wherein the roller tube comprises a substantially cylindrical wall comprising the substantially cylindrical outer surface and an inner cavity with a substantially cylindrical inner surface, wherein the channel is formed in the cylindrical wall of the roller tube such that it is substantially contained within the cylindrical wall and does not protrude beyond the perimeter of the substantially cylindrical outer surface or beyond the perimeter of the substantially cylindrical inner surface into the inner cavity of the roller tube.

19. The roller shade of claim 18, wherein the cylindrical wall of the roller tube comprises a substantially constant thickness such that the inner surface is substantially concentric with the outer surface.

20. A channel for receiving a retaining member to secure shade material to a roller shade, the channel comprising:
a first and second retaining lip sections that define an opening into the interior cavity of the channel;
a first bottom wall section opposite the first retaining lip and aligned along a first plane;
a second bottom wall section opposite the second retaining lip and aligned along a second plane offset from the first plane;
wherein the second retaining lip comprises an outer lip wall that tapers towards the interior cavity and is aligned along the same first plane as the first bottom wall section;
wherein a top end of the retaining member is inserted through the opening and into the interior cavity along the first plane under the first retaining lip and over the outer lip wall and the first bottom wall section, and wherein the retaining member rotated into place from being aligned with the first plane to being aligned with the second plane such that a bottom end of the retaining member is positioned between the second retaining lip and the second bottom wall section, wherein the retaining member secures a portion of the shade material within the interior cavity of the channel.

21. A method for securing shade material to a roller shade comprising a channel having an opening between a first retaining lip and a second retaining lip, an interior cavity, a first bottom wall section opposite the first retaining lip and aligned along a first plane, and a second bottom wall section opposite the second retaining lip and aligned along a second plane offset from the first plane, wherein the second retaining lip comprises an outer lip wall that tapers towards the interior cavity and is aligned along the same first plane as the first bottom wall section, the method comprising the steps of:
wrapping a top end of a retaining member with the shade material;
inserting the top end of the retaining member through the opening into the interior cavity along the first plane under the first retaining lip and over the outer lip wall and the first bottom wall section; and
rotating the retaining member from being aligned with the first plane to being aligned with the second plane, wherein the bottom end of the retaining member is slid along the second plane until being positioned between the second retaining lip and the second bottom wall section.

22. The method of claim 21, wherein the step of wrapping a top end of a retaining member with the shade material comprises:
attaching the top end of the shade material to a first side of the retaining member; and
folding the shade material over a second side of the retaining member.

23. A roller shade comprising:
a shade material comprising a bottom end;
a retaining member; and
a hem bar comprising an outer surface and a channel recessed in the outer surface, wherein the channel comprises:
an opening in the outer surface of the hem bar that extends between a first retaining lip and a second retaining lip and provides access into an interior cavity of the channel;
a bottom wall comprising a first bottom wall section opposite the first retaining lip and aligned along a first plane, and a second bottom wall section opposite the second retaining lip and aligned along a second plane offset from the first plane; and
an outer lip wall that extends from the outer surface of the hem bar to a tip of the second retaining lip and tapers towards the interior cavity, wherein the outer lip wall is aligned along the same first plane as the first bottom wall section;
wherein the retaining member secures the bottom end of the shade material within the interior cavity of the channel in the hem bar.
